(19) United States
(12) Patent Application Publication
(10) Pub. No.: US 2024/0294366 A1
(43) Pub. Date: Sep. 5, 2024

(54) STANDALONE JACK FOR VEHICLES

(71) Applicant: Ciro John PORRICELLI, Greenwich, CT (US)

(72) Inventor: Ciro John PORRICELLI, Greenwich, CT (US)

(21) Appl. No.: 18/590,648

(22) Filed: Feb. 28, 2024

Related U.S. Application Data
(60) Provisional application No. 63/487,905, filed on Mar. 2, 2023.

(51) Int. Cl. B66F 5/04

(52) U.S. Cl. CPC B66F 5/04

(57) ABSTRACT

A vehicle part support assembly is included that has a frame, a jack supported on the frame that moves a ram, a platform support that contacts the ram, and a platform that is connected to the platform support so that movement of the ram adjusts a height of the platform.

### CROSS REFERENCE TO RELATED APPLICATIONS

This application claims the benefit of U.S. Provisional Application No. 63/487,905 filed Mar. 2, 2023, the contents of which are incorporated by reference herein.

### BACKGROUND

### 1. Field of the Invention

The present disclosure is related to vehicle repair. More particularly, the present disclosure is related to a standalone jack for repair of vehicles.

### 2. Description of Related Art

Currently, moving large and/or heavy vehicle parts, for example, tires and doors of a car, in an auto repair garage often results in injuries. Mechanics often remove large and/or heavy parts from a vehicle manually. Moving the large and/or heavy vehicle parts from one location to another is also generally done manually leading to further injuries. Still further, mechanics often manually remove large and/or heavy parts from a car on a lift and place the large and/or heavy parts on the floor, which can be dangerous and lead to injuries.

Accordingly, it has been determined by the present disclosure that there is a continuing need for a device that supports large and/or heavy parts once they are removed from a vehicle to overcome, alleviate, and/or mitigate one or more of the aforementioned and other deleterious effects of prior devices.

### SUMMARY

The present disclosure provides a standalone jack for use with vehicles that can be operated by a single person.

The present disclosure further provides such a standalone jack that can allow a single person to remove a large and/or heavy vehicle part without assistance.

A vehicle part support assembly is provided that includes a frame, a jack supported on the frame that moves a ram, a platform support that contacts the ram, and a platform that is connected to the platform support so that movement of the ram adjusts a height of the platform.

The above-described and other features and advantages of the present disclosure will be appreciated and understood by those skilled in the art from the following detailed description, drawings, and appended claims.

### DESCRIPTION OF THE DRAWINGS

FIG. 1 is a left side perspective view of a standalone jack assembly for vehicles of the present disclosure in an intermediate position.

FIG. 2 is a rear view of FIG. 1.

FIG. 3 is a right side view of FIG. 1.

FIG. 4 is a partial enlarged front perspective view of FIG. 1.

FIG. 5 is a left side perspective view of the standalone jack assembly of FIG. 1 having a platform in a lowered position.

FIG. 6 is a left side perspective view of the standalone jack assembly of FIG. 1 having a platform in a raised position.

FIG. 7 is a partial enlarged front perspective view of FIG. 1.

### DETAILED DESCRIPTION

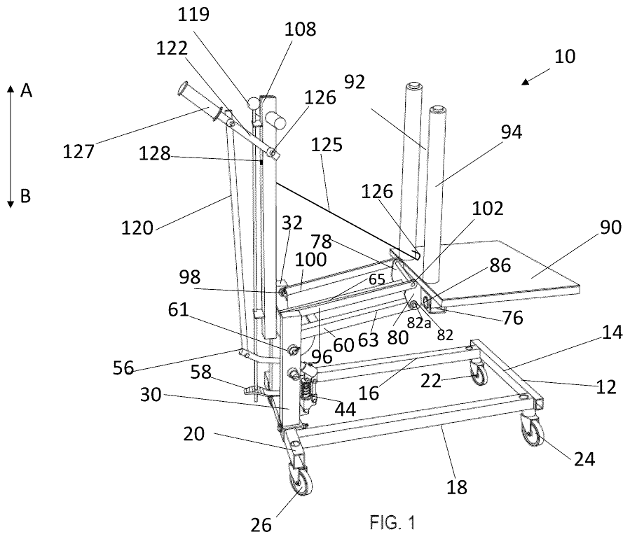

Referring to the drawings and in particular to FIG. 1, an exemplary embodiment of a standalone jack assembly for vehicles according to the present disclosure is shown and is generally referred to by reference numeral 10 (“assembly 10”). Advantageously, while repairing vehicles, a single person/auto mechanic can place a car part that has been removed from a vehicle on assembly 10. With assembly 10, the auto mechanic can easily transport the cart part to a desired location after removal. Another advantage is that assembly 10 has an adjustable height to allow use with vehicles of different heights. Moreover, assembly 10 can additionally accommodate large and/or heavy vehicle parts, for example, doors, tires, front and rear bumpers, radiator supports and the removal of such large and/or heavy parts from such vehicles that otherwise requires several people to remove and with a great deal of physical exertion.

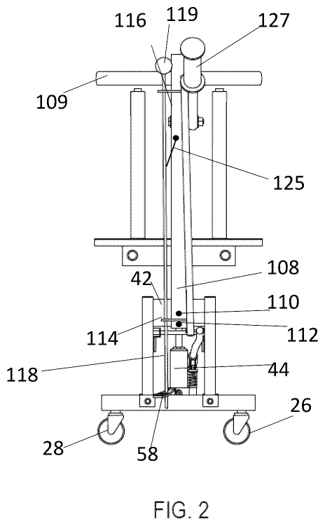

Referring to FIG. 1, assembly 10 has a bottom frame 12. Bottom frame 12 has a front member 14, a first side member 16, a second side member 18 and a rear member 20 forming a rectangular shape. Each of front member 14, first side member 16, second side member 18 and rear member 20 can be a metal bar. Bottom frame 12 is connected to wheels 22, 24, 26, 28 (FIG. 2) on a bottom side of bottom frame 12.

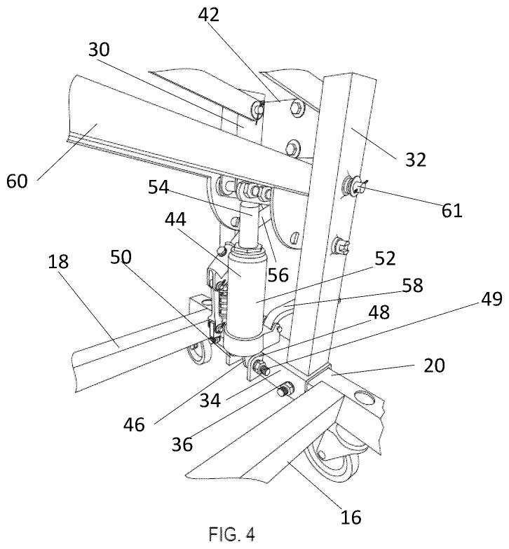

Referring to FIG. 4, rear member 20 of bottom frame 12 is connected to a first intermediate member 30 and a second intermediate member 32 on a top side that is opposite the bottom side of frame 12. First intermediate member 30 and second intermediate member 32 are connected to an upside down U-shape member 34 that fits over rear member 20 so that U-shape member 34 extends on opposite sides of rear member 20 allowing a fastener 36, for example, a bolt, to pass through U-shape member 34 and rear member 20 on opposite sides of rear member 20. First intermediate member 30 and second intermediate member 32 are connected by a cross member 42 on a side opposite bottom frame 12.

Still referring to FIG. 4, U-shape member 34 is connected to a jack 44. Jack 44 is positioned between first intermediate member 30 and second intermediate member 32. Jack 32 has a loop 46 extending from a bottom side. U-shape member 34 has loops 48, 50 that extend from a surface of U-shape member 34 that face front member 14. Loop 46 of jack 32 is positioned between and aligned with loops 48, 50 of U-shape member 34 so that a fastener 49, for example, a bolt, passes through each of loop 46 and loops 48, 50 fastening jack 44 to U-shape member 34. Jack 44 is a car or vehicle jack and can be, for example, a Maasdam Pow'r Lift™ 4 ton bottle jack. Jack 44 has a housing 52, a ram 54, a lift lever 56 and a release lever 58.

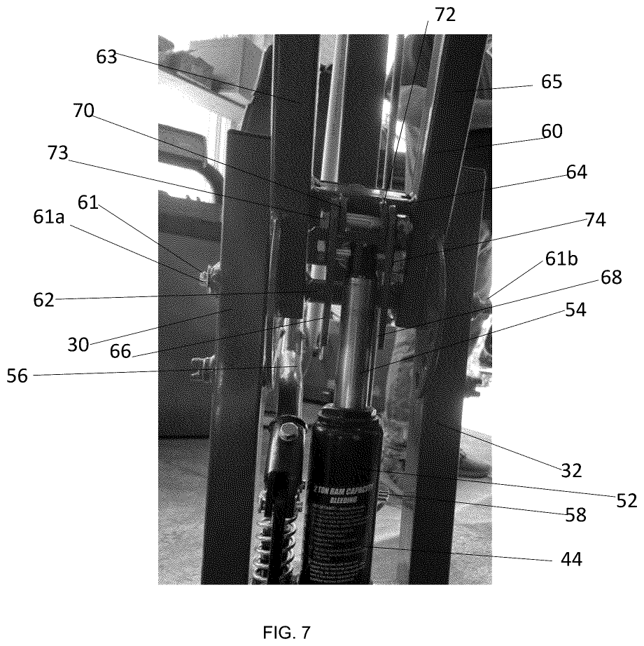

Referring to FIG. 7, ram 54 is connected to a platform support 60. Platform support 60 is connected between first intermediate member 30 and second intermediate member 32 by a fastener 61, for example, a rod 61a and pin 61b, so that platform support 60 is rotatable about fastener 61. Platform support 60 has a first cross member 62 and a second cross member 64 that connect to a first member 63 and a second member 65. Platform support 60 has connection members 66, 68 that extend from first cross member 62. Platform support 60 has loops 70, 72 extending from second cross member 64. Connection members 66, 68 each have openings that align with openings in loops 70, 72 so a fastener 73, for example, a bolt, passes through the openings in loops 70, 72 and the openings through connection members 66, 68. Connection members 66, 68 each have openings that align with an opening through ram 54 so a fastener 74, for example, a bolt, passes therethrough to secure ram 54 to connection members 66, 68 so that connection members 66, 68 are rotatable about fastener 74.

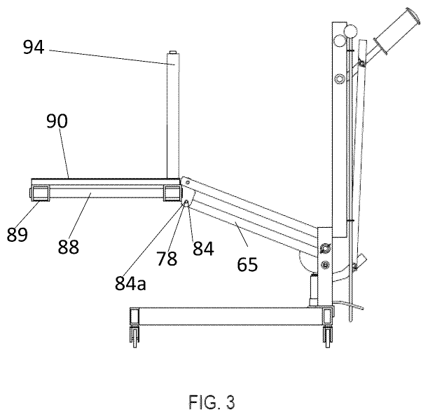

Referring back to FIG. 1, platform support 60 is connected to a platform bar 76. Platform bar 76 has tabs 78, 80. Tab 78 has an opening. First member 63 connects to tab 80 by a fastener 82, for example, a bolt 82a, that passes through an opening through first member 63 that is aligned with the opening through tab 80 so that first member 63 is rotatable about fastener 82 and platform bar 76 is rotatable about fastener 82. Second member 65 connects to tab 78 by a fastener 84 (FIG. 3), for example, a bolt 84a, that passes through an opening through second member 65 that is aligned with an opening through tab 78 so that second member 65 is rotatable about fastener 84 and platform bar 76 is rotatable about fastener 84.

As shown in FIGS. 1 and 3, platform bar 76 is connected to platform supports 86, 88 that connect to support bar 89 to support platform 90. Vertical supports 92, 94 extend from platform bar 76 through platform 90.

Still referring to FIG. 1, a first support member 96 is connected to first intermediate member 30 by a fastener, for example, a rod and pin, so that first support member 96 is rotatable about fastener. A second support member 100 is connected to second intermediate member 32 by a fastener 98, for example, a rod and pin, so that second support member 100 is rotatable about fastener 98, the same as first support member 96 rotates about the fastener connecting first support member 96 to first intermediate member 30. First support member 96 connects to tab 80 of platform bar 76 by a fastener 102, for example, a bolt, which passes through an opening through first support member 96 that is aligned with an opening through tab 80 so that first support member 96 is rotatable about fastener 102 and platform bar 76 is rotatable about fastener 102. Second support member 100 connects to tab 78 of platform bar 76 by fastener 102 that passes through an opening through second support member 100 that is aligned with an opening through tab 78 so that second support member 100 is rotatable about fastener 102 and platform bar 76 is rotatable about fastener 102.

Referring to FIGS. 2 and 4, cross member 42 is connected to a handle support 108 on a first end. A handle 109 is connected to handle support 108 on a second end that is opposite the first end. A first fastener 110, for example, a bolt, passes through aligned openings in cross member 42 and handle support 108 and a second fastener 112, for example, a bolt, passes through other aligned openings in cross member 42 and handle support 108.

Referring to FIG. 2, handle support 108 has a first rod support 114 and a second rod support 116. A release rod 118 extends through openings in each of first rod support 114 and second rod support 116 and connects to release lever 58 positioning release rod 118 adjacent to handle support 108. Release rod 118 has a gripper 119 on a first end opposite a second end that connects to release lever 58.

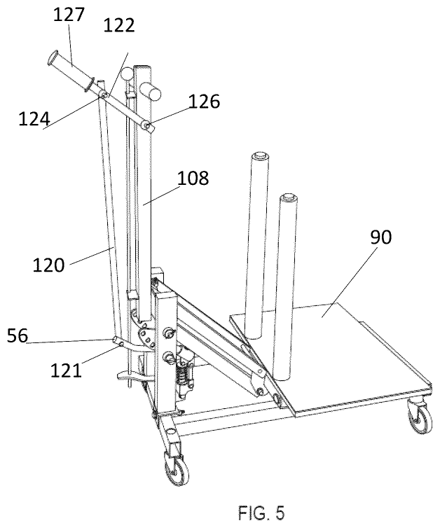

Referring to FIG. 5, lift lever 56 is connected to a lift rod 120 by a fastener 121, for example, a rod and pin, so that lift rod 120 is rotatable about fastener 121 and lift lever 56 is rotatable about fastener 121. Lift rod 120 is connected to a handle rod 122 by a fastener 124, for example, a rod and pin, so that lift rod 120 is rotatable about fastener 124 and handle rod 122 is rotatable about fastener 124. Handle rod 122 is connected to handle support 108 by a fastener 126, for example, a rod and pin, so that handle rod 122 is rotatable about fastener 126. Handle rod 122 has a handle 127 that a user can grip. Assembly 10 is made from material that is strong enough to support tires and doors of vehicles, for example, a sedan and/or a sports utility vehicle (“SUV”), that is made, for example, of metal and/or plastic.

As shown in FIG. 1, handle support 108 also connects to a rope or bungee 125 that has a hook 126 at a second end. Second end is opposite a first end of rope or bungee 125 and rope or bungee 125 connects to handle support 108. Rope or bungee 125 can connect to a loop 128 that extends from handle support 108.

Assembly 10 has a number of wheels 22, 24, 26, 28. Wheels 22, 24, 26, 28 permit for easy movement of assembly 10 to a desired location by a user, even with a vehicle part thereon.

For use or operation of assembly 10, a user grips handle 127 and reciprocates handle 127 upwards and downwards in alternating direction A and direction B to rotate handle rod 122 about fastener 126 so that handle rod 122 moves lift rod 120 and lift lever 56 upwards and downwards in alternating direction A and direction B. The movement of lift rod 120 and lift lever 56 upwards and downwards in alternating direction A and direction B actuates jack 44 to move ram 54 upwards in direction A. For example, movement of lift lever 56 upwards and downwards in alternating direction A and direction B moves a piston to compress air in housing 52 and the compressed air exerts a force on ram 54 urging ram 54 upwards in direction A.

Referring to FIG. 4, movement of ram 54 upwards in direction A pushes or rotates platform support 60 to move about fastener 61 to move platform bar 76 and platform 90 upwards in direction A, as shown in FIG. 1. The user reciprocates handle 27 upwards and downwards in alternating direction A and direction B until platform 90 is in a desired position. If the user wants to move platform 90 downwards in direction B, the user grips gripper 119 and pushes release rod 118 downward in direction B that actuates jack 44 to lower ram 54. For example, moving release lever 58 downward in direction B allows the compressed air to exit housing 52 to lower pressure in housing 52 so that the force exerted on ram 54 is less thus allowing ram 54 to lower in housing 52. Movement of ram 54 downwards in direction B rotates platform support 60 to move about fastener 61 to move platform bar 76 and platform 90 downwards in direction B. The user pushes release rod 118 downward in direction B until platform 90 is in a desired position and then the user moves or allows release rod 118 to move back upwards to its original position shown in FIG. 1.

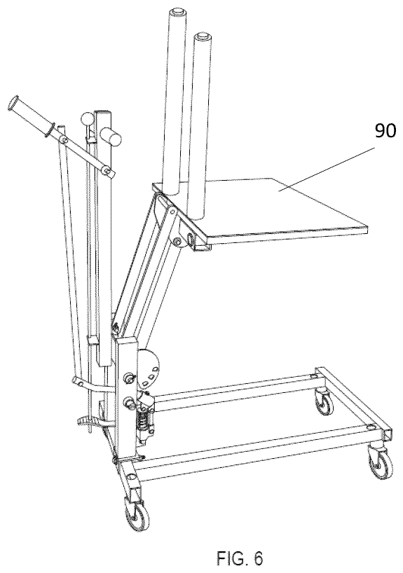

FIG. 5 shows platform 90 is the lowest position and FIG. 6 shows platform 90 is the highest position. Platform 90 is adjustable to positions between the lowest position and the highest position. When an item, for example, a car part, is supported on platform 90, hook 126 can be positioned around a portion of the item to maintain the item on platform 90.

Assembly 10 allows users to move large and/or heavy vehicle parts with one person and also prevents injuries normally caused by physical exertion caused by the carrying of heavy parts. Also, assembly 10 can support one or more car parts that have been removed from a vehicle. Assembly 10 can also transport the cart part to a desired location after removal. Assembly 10 additionally has an adjustable height to allow use with vehicles of different heights and/or vehicles on a lift. Thus, assembly 10 accommodates large and/or heavy and even odd shaped vehicle parts, for example, doors, tires, front and rear bumpers, and radiator supports of cars or trucks and allows for their removal and movement and reassembly by one user, namely an auto mechanic or assistant.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure is not limited to the particular embodiment(s) disclosed as the best mode contemplated, but that the disclosure will include all embodiments falling within the scope of the disclosure.

What is claimed is:

1. A vehicle part support assembly comprising:
a frame;
a jack supported on the frame that moves a ram;
a platform support that contacts the ram; and
a platform that is connected to the platform support so that movement of the ram adjusts a height of the platform.

2. The vehicle part support assembly of claim 1, wherein the frame is connected to a plurality of wheels to move the vehicle part support assembly from a first location to a second location.

3. The vehicle part support assembly of claim 1, wherein the frame is connected to a handle support that is connected to a handle.

4. The vehicle part support assembly of claim 3, wherein the jack has a lift lever and a release lever, and wherein the lift lever is connected to a lift rod that is connected to a handle rod that has a handle that is engageable to reciprocate the lift rod and lift lever upwards and downwards.

5. The vehicle part support assembly of claim 4, wherein the release lever is connected to a release rod that is engageable to move the release lever upwards and downwards.

6. The vehicle part support assembly of claim 1, wherein the platform support has a first end that is rotatably connected to a first intermediate member and a second intermediate member that are each connected to the frame.

7. The vehicle part support assembly of claim 6, wherein the platform support has a second end that is opposite the first end that is rotatably connected to the platform.

8. The vehicle part support assembly of claim 7, wherein the first intermediate member and the second intermediate member are connected by a cross member, and wherein the cross member is connected to a handle support that is connected to a handle.

9. The vehicle part support assembly of claim 3, wherein the handle support is connected to a rope or bungee that has a hook.

10. The vehicle part support assembly of claim 1, wherein the platform is supported by a platform bar that is connected to a pair of platform supports that connect to a support bar.

11. The vehicle part support assembly of claim 10, wherein the platform has vertical supports that extend from the platform bar through the platform.
